(19) United States
(12) Patent Application Publication
(10) Pub. No.: US 2005/0036801 A1
(43) Pub. Date: Feb. 17, 2005

(54) Casing for an electronic circuit

(75) Inventor: Lynton R. Burchette, Sanford, NC (US)

Correspondence Address: WILLIAM L. LONDON, 3010 LEE AVENUE, P.O. BOX 152, SANFORD, NC, 27330, US

(73) Assignee: Static Control Components, Sanford, NC (US)

(21) Appl. No.: 10/701,304

(22) Filed: Mar. 30, 2004

Related U.S. Application Data
(63) Continuation-in-part of application No. 10/641,617, filed on Aug. 15, 2003.

(51) Int. Cl. G03G 15/00

(52) U.S. Cl. 399/109

(57) ABSTRACT

An apparatus for housing an electronic circuit in a remanufactured replaceable consumable unit having unique characteristics that facilitate the removal of the casing after it has been mounted onto the replaceable consumable unit, once the replaceable consumable unit is later refurbished, the characteristics including various physical dimensional variations of the walls of the casing, the physical dimensional variations being either an indentation, a protrusion, or a removal fixture integrated into the design of the casing, the casing further designed to fit within a specific mounting location on the replaceable consumable unit.

### CROSS-REFERENCE TO RELATED APPLICATIONS

This patent is a Continuation-In-Part of patent application Ser. No. 10/641,617 filed Aug. 15, 2003.

### BACKGROUND

The present invention relates to a casing for an electronic circuit, and more particularly to a casing for housing an electronic circuit for use in a remanufactured replaceable consumable unit. A typical replaceable consumable unit such as a toner cartridge, ink jet cartridge, Organic Photo Conductor (OPC) drum assemblies or the like may be used in various types of imaging devices such as printers, copiers, or fax machines. These replaceable consumable units may contain many different components. Some examples of components may include toner, ink, the OPC drum, developer roller, electronic circuits and so forth. The replaceable consumable units may also vary between monochrome and color based devices. As technology continues to change, there is no end in sight to the variations of replaceable consumable units that will be necessary to interoperate with new imaging devices.

Along with the moveable parts, imaging device manufacturers have also started storing information on the replaceable consumable unit. In some of the earlier replaceable consumable units, the Original Equipment Manufacturers (OEM's) devised a way of detecting specific information that was stored on the replaceable consumable unit itself. This was done via a mechanical process. With electronic circuits becoming smaller in physical size, more efficient in terms of increased storage capacity and able to perform more complex tasks, imaging devices are increasingly moving additional information to the replaceable consumable units. For example, information such as operating voltage, cartridge serial number, manufacturing history, printer history, toner consumption, and remaining toner may be stored within memory on the cartridge. This allows the information associated with a specific replaceable consumable unit to move with the replaceable consumable unit should it be transported from one imaging device to another. It also allows the manufacturer to track the cartridge during its lifetime.

In order to protect its profitability, some OEM's have designed the replaceable consumable unit to be a single use product. Once the product had reached the end of its life, the OEM anticipated that the consumer would discard the used part and replace it with a new replaceable consumable unit. Additionally, the OEM has ensured that the replaceable consumable units may not simply be refilled with toner and placed back into service, by installing protection measures on the replaceable consumable unit. For example, OEM's have installed a one-time writable electronic circuit onto the replaceable consumable unit itself. The imaging device has the ability to interface with this electronic circuitry and once this circuit has been disabled, the replaceable consumable unit ceases to function.

An industry known as the Remanufacturing Industry has evolved to address the refurbishing of these replaceable consumable units. Even though the OEM's may have initially wanted the replaceable consumable unit to be single use only, many of the components and assemblies were still reusable. The remanufacturer may be able to take the spent replaceable consumable unit, disassemble it, replace the worn or broken components and then reintroduce the recycled product back into the stream of commerce. Part of the refurbishment process may include the removal of electronic circuitry mounted on the replaceable consumable unit.

During the refurbishment process, one problem encountered with the current designs of replaceable consumable units is that the electronic circuitry may not be easily physically removed. The electronic circuitry is usually mounted on the exterior of the replaceable consumable unit and held in place with some type of adhesive. The area where the electronic circuit is mounted may be cramped with no space to insert a removal tool. The present invention is intended to facilitate the removal process.

### SUMMARY

In accordance with an embodiment of the present invention, a casing used to house an electronic circuit includes a plurality of walls, and a feature for making the casing easier to remove. This feature may be a protrusion or the like that allows a service technician to use a tool to pry the casing away from the replaceable consumable unit by applying pressure against the feature and the area on the replaceable consumable unit to which the casing is mounted. The feature may also be an indentation that allows the service technician to place a tool between the casing and the replaceable consumable unit. The feature may also take the form of a fixture formed on the casing that may be used by the service technician to pull the casing away from the replaceable consumable unit without having to pry the casing.

### BRIEF DESCRIPTION OF THE DRAWINGS

FIG. 1 is a perspective view of a prior art printer cartridge.

FIG. 2 is a perspective view of a prior art electronic circuit board.

FIG. 3 is a perspective view of a prior art waste bin assembly.

FIG. 4 is a schematic diagram illustrating a replacement electronic circuit for use in a replaceable consumable unit in accordance with an embodiment of the present invention.

FIG. 5A is a top perspective view of a replacement electronic circuit in accordance with one embodiment of the present invention.

FIG. 5B is a bottom perspective view of a replacement electronic circuit in accordance with one embodiment of the present invention with a prior art electronic circuit board attached.

FIG. 6 is an exploded view of a replacement electronic circuit in accordance with one embodiment of the present invention prior to being connected to a prior art electronic circuit board.

FIG. 7 is a top perspective view of a replacement electronic circuit in accordance with one embodiment of the present invention connected with wires to a prior art electronic circuit board.

FIG. 8 is a flow chart of an example of a method that may be performed by replacement electronic circuit logic in accordance with an embodiment of the present invention.

FIG. 9 is a schematic diagram illustrating a replacement electronic circuit for use in a replaceable consumable unit in accordance with another embodiment of the present invention.

FIG. 10 is a perspective view of a replacement electronic circuit for use in a replaceable consumable unit in accordance with another embodiment of the present invention.

FIG. 11 is a perspective view of a prior art toner hopper assembly of another replaceable consumable unit.

FIG. 12 is a perspective view of a prior art electronic circuit casing.

FIG. 13A is a perspective view of a casing having an end wall indentation for use in housing an electronic circuit in accordance with an embodiment of the present invention.

FIG. 13B is a bottom view of a casing in FIG. 13A having an end wall indentation for use in housing an electronic circuit in accordance with an embodiment of the present invention.

FIG. 14 is a perspective view of a casing having a sidewall indentation for use in housing an electronic circuit in accordance with an embodiment of the present invention.

FIG. 15 is a perspective view of a casing with a protrusion in accordance with an embodiment of the present invention.

FIG. 16 is a perspective view of a casing with a removal fixture in accordance with an embodiment of the present invention.

FIG. 17 is a perspective view of a replacement casing with an alternative removal fixture in accordance with an embodiment of the present invention.

FIG. 18 is a perspective view of another prior art printer cartridge.

FIG. 19 is a perspective view of another prior art waste bin assembly of a printer cartridge.

### DETAILED DESCRIPTION

The following detailed description of preferred embodiments refers to the accompanying drawings which illustrate specific embodiments of the invention. Henceforth the embodiments of the present invention will be described with reference to a toner cartridge for use in a printer. Other embodiments having different structures and operations do not depart from the scope of the present invention.

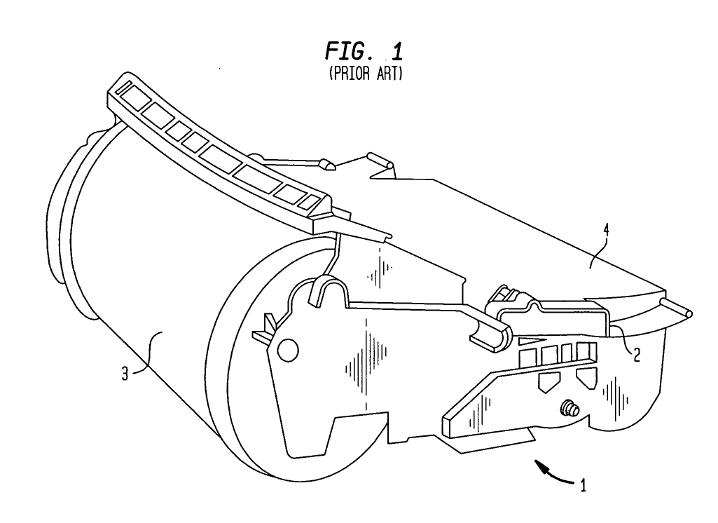

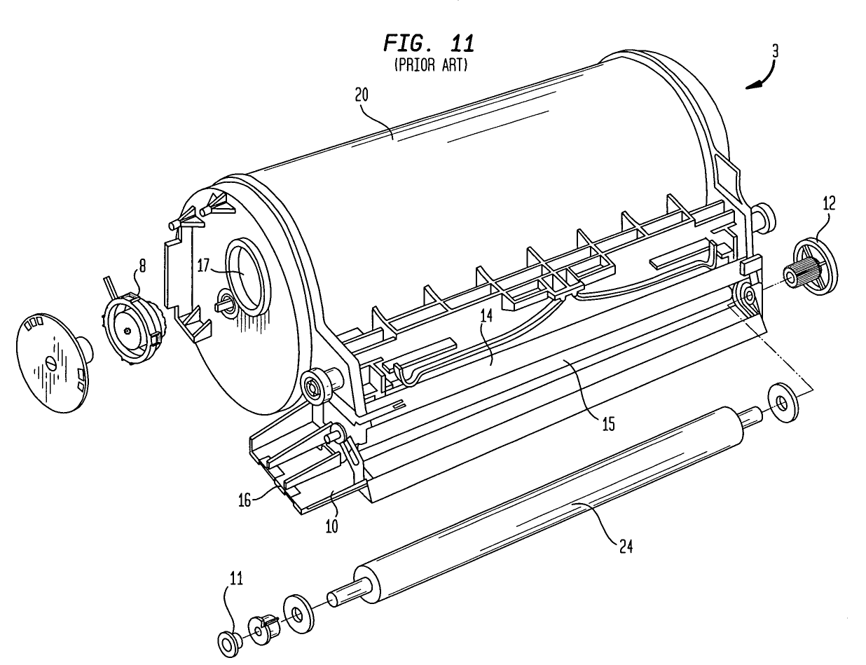

FIG. 1 is an illustration of a prior art toner cartridge. This toner cartridge comprises several subassemblies and subcomponents. A more detailed illustration of the toner hopper portion of this cartridge is shown in FIG. 11. The remanufacturer will take the spent or used cartridge, disassemble it down to a serviceable level and then replace the worn out or broken items. After servicing the cartridge the remanufacturer reassembles the pieces back into a fully functional unit and introduces this refurbished product into the marketplace.

The newer toner cartridges have an electronic circuit, which is utilized for various functions. This circuitry may be used to store information that is unique to the specific toner cartridge. Information that may be stored in this electronic circuit may include data such as the serial number of the cartridge, the model type, the yield, the amount of toner remaining and so forth. The printer may periodically access the information stored in the electronic circuit during the life cycle of the cartridges. Whenever the cover of a printer is opened or if the power is turned back on, the printer may query the printer cartridge to obtain its current status. This query may be due to the fact that the printer does not know if it is the same cartridge that was installed prior to the opening and closing of the printer cover. The printer may need to know the cartridge characteristics of the cartridge since it may set certain parameters based on this information.

This electronic circuit has also been used to thwart any recycling of these replaceable consumable units by third parties not affiliated with the OEM. The OEM's have employed various methods to make any refurbishment of the cartridges extremely difficult if not impossible. To begin with, the circuit is designed to become disabled by the printer once the toner level has reached an empty state. Another level of difficulty is that the two components may employ a unique communication scheme. Additionally, the printer might require a validation of the communication. Another level of difficulty that the printer could employ could involve an encryption of the communications in addition to the validation. The list of different ways to encode this information and lock out a third party is endless.

A replacement electronic circuit may be introduced to repair the nonfunctional original electronic circuit during the refurbishment process. This replacement electronic circuit may allow the circuit to still operate, but all communications with the printer would be intercepted. The replacement electronic circuit may have the capability of monitoring the communications going back and forth between the printer and the original electronic circuit. By monitoring the communications coming from the printer, the replacement electronic circuit may intercept, process and resend the data to the original electronic circuit. The original electronic circuit responds accordingly and this is retransmitted to the printer. A processor may also be able to determine when the specific memory locations corresponding to the toner level are being accessed and will subsequently use its own memory locations to store this information. The processor in the recent example may provide a new memory location that would store the toner bucket level. Once the cartridge using the replacement electronic circuit has depleted all of the usable toner the printer will once more write the appropriate value in the correct memory location and the processor may be instructed to disable the ability to change this memory location. The cartridge may then be sent back to be recycled.

In order for the replacement electronic circuit mounted on a replaceable consumable unit to function properly, the replacement electronic circuit must effectively communicate with the printer. As is common in any bi-directional communication architecture, both communicating devices may be able to send and receive information according to an agreed upon protocol and timing criteria. Each printer or family of printers may employ unique protocol schemes. In another illustration, the replacement electronic circuit may communicate with the printer via a one-wire bus architecture protocol. This is the protocol used by several different OEM printer manufacturers. This protocol is based on a one-wire standard developed by Dallas Semiconductor. The printers employing this standard may use a Dallas DS2432 chip to facilitate the communications function on the replaceable consumable unit. Any replacement circuit must be able to emulate this protocol.

The Dallas DS2432 chip also employs a verification technique called SHA-1 or Secure Hash Algorithm-1. This hash algorithm was first created for the Federal Government to be used in conjunction with an encryption scheme. The difference between an encryption algorithm and a hash algorithm is that the hash is unidirectional or one way only. Once information is encoded into an encryption scheme, the data may be extracted once the key is used to unlock the information. This is in contrast to the hash computation because the data is not recoverable once it is used in computing the hash. The hash algorithm is used as a complex way of verifying data integrity similar to the basic cyclic redundancy check that exists in many of the early data communication designs. The SHA-1 algorithm has become an accepted standard for data transmission verification. It uses a complex scheme of mathematical equations and data manipulations to “process” a 64-byte input and determine a 20-byte response sequence. What makes this process unique, when applied in conjunction to this Dallas part, is that of the 64-byte input, 8-bytes are pseudo random data that is stored in a “secret” location which is unreadable. These 8-bytes are downloaded into the part when it is initially stored with data at the factory. Anyone who is skilled in the art might be able to decipher the formula for determining this random data being loaded into this secret location by crunching all of the different possible combinations of the 8-bytes. The total number of combinations would be roughly 1.845×10¹⁹. As one could imagine the number crunching might possibly take years if all the possible combinations were tested.

When refurbishing replaceable consumable units, remanufacturers have been limited in what they are able to do to repair these circuits once they have become disabled. If a completely independent replacement circuit were to be developed, it would have to be able to implement this random number. Without the actual knowledge of how it is generated, a remanufacturer would have to generate random numbers until one could be found that would be compatible with a certain set of circuit data. It is analogous to searching for the proverbial needle in a haystack. Absent the ability to decipher the hash, a replacement electronic circuitry is essentially worthless without the original electronic circuit. As pointed out previously, these techniques may be proprietary or extremely difficult to understand. Thus the printer and electronic circuit must be able to communicate and “shake hands” in order for a toner cartridge with such circuitry to be functional within the printer. One aspect of the present invention takes advantage of the nonfunctional electronic circuits capability to speak the unique language as well as employ the encryption protocol. Additionally, once the authentication sequence has been deciphered, a fully functional replacement device employing this technique may be offered utilizing this scheme.

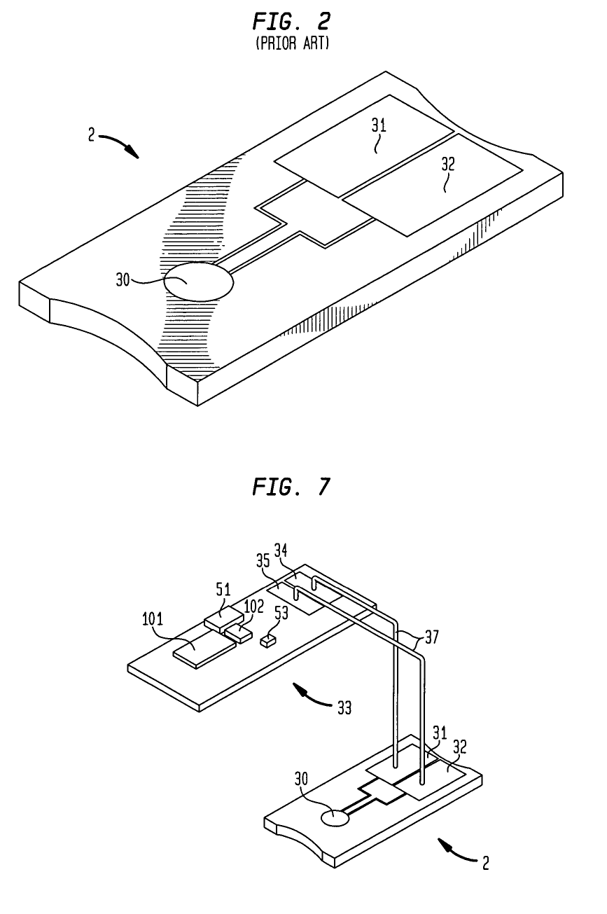

In order to interface with the electronic circuit some printers use electrical contacts. When the toner cartridge is inserted, these printer contacts make an electrical connection with the contacts of the electronic circuit. FIG. 2 is an illustration of an example of an original electronic circuit 2 employing an electrical contact type interface. All of the discrete logic 30 for the electronic circuit is located on the top surface of the original electronic circuit 2. The original electronic circuit 2 contains two printer interfacing electrical contacts, an original electronic circuit data contact 32 and an original electronic circuit ground contact 31. Because the printer's electrical contacts (not shown) are fixed, the contacts of the first circuit board as well as contacts for any replacement circuit must be within their reach and maintain the proper orientation. These printer contacts may be metal springs, clips, or other types of conductive material so that when the cartridge is inserted into the printer, the weight of the cartridge, as well as the closing of the printer cover, will exert enough pressure to ensure sufficient and reliable electrical connection.

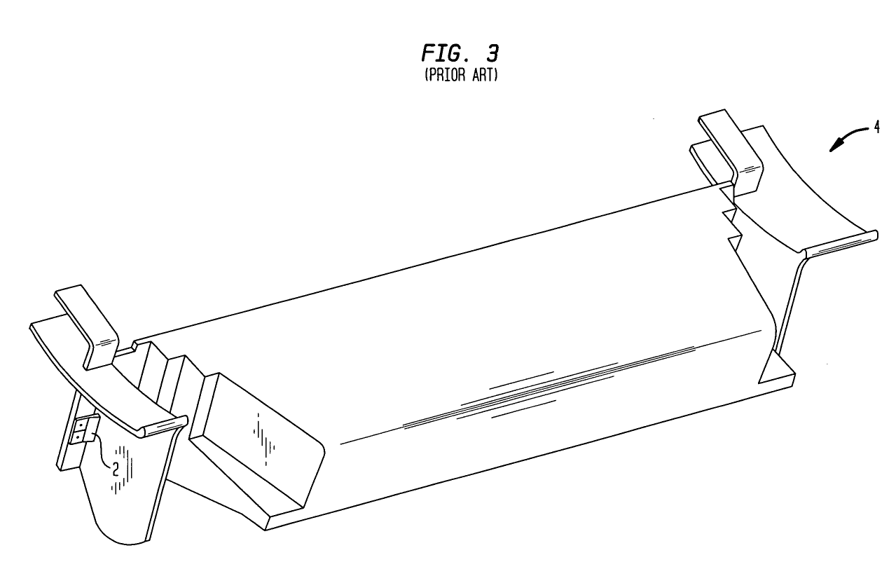

Examining some of the prior art toner cartridges, one can show an excellent application of the previously discussed principles. FIG. 1 shows a prior art printer cartridge 1. This cartridge 1 employs a contact type of communication between the printer and the original electronic circuit 2 mounted on the toner cartridge 1. When fully assembled, the cartridge 1 has a toner hopper assembly 3 and a waste bin assembly 4. On the side of the waste bin assembly 4, the original electronic circuit 2 is located. FIG. 3 shows in greater detail the location of the original electronic circuit 2 in a side area of the waste bin assembly. Here the two printer interfacing contacts of the original electronic circuit 2 are clearly shown.

Other printers may incorporate a wireless communication method to interface to the circuit on the toner cartridge. The same concepts regarding storage of information as applied in the previous prior art cartridge have been adapted for use in the wireless applications. In making the recycling process for the toner cartridge more difficult, the wireless example disables the circuit on the replaceable consumable unit once it has determined that no usable toner remains in the cartridge. To disable the cartridge the printer will write a “disable” value to a specific location in the memory of the circuit. Once written, this memory address may not be overwritten. Simple replacement of this circuit may not be feasible if the communication between the printer and the cartridge employs a unique language or encryption. Therefore, the present invention is applicable to both types of printers since the replacement electronic circuit will take advantage of the original electronic circuit's ability to speak the printer language as well as provide a new memory location for this disabling value.

As applied to the contact toner cartridge, a 16-bit processor may be used. These types of processors may provide a way to communicate between the nonfunctional original electronic circuit on the toner cartridge and the printer. The characteristics that are to be taken into account when choosing a processor is the processor's ability to function at low voltages, low power dissipation, and low cost. In this particular application the processor may be limited to an operating voltage that may vary between about 3.0 V DC and about 4.2 V DC. An additional design restriction for this replacement electronic circuit may be the amount of current that will be able to be sourced at any given time. One possible processor that might be used in an embodiment of the present invention may be the Texas Instruments MSP430F1121A, as this particular processor may operate within the guideline parameters.

When a replacement electronic circuit is installed in conjunction with an original electronic circuit, the replacement electronic circuit together with the original electronic circuit may not exceed the power limitations of the printer supply. The power for these circuits will be derived from the one-wire contacts. Under normal operating conditions this particular microcontroller will require approximately 160 μA to function. When evaluating a replacement circuit alternative, caution must be taken not to overdrive the printer data circuit. Not only must the communications be conducted over these contacts but the power to run these devices must also be supplied from them as well.

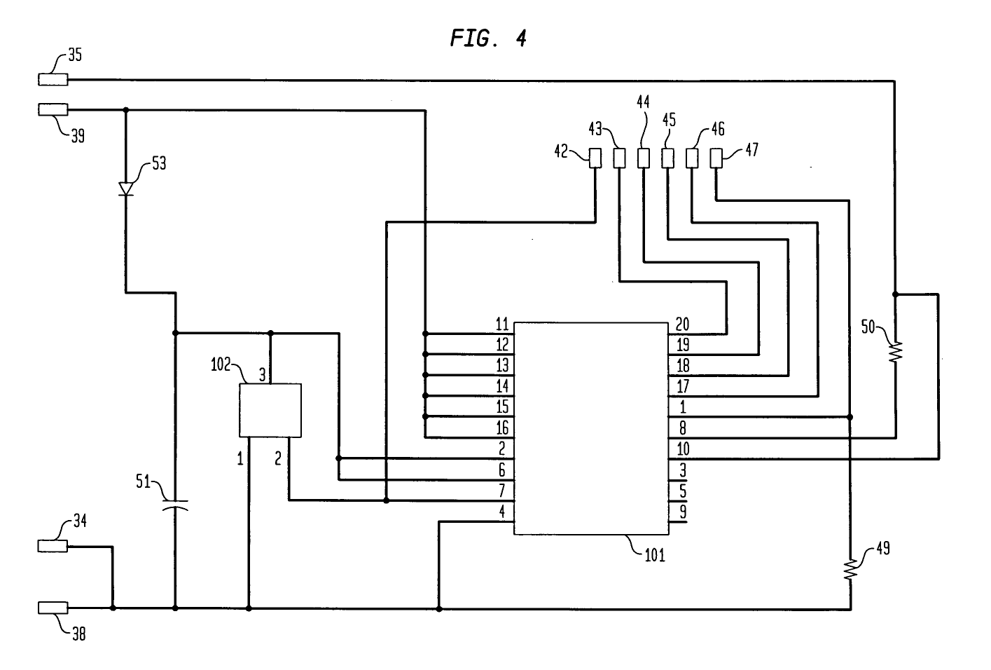

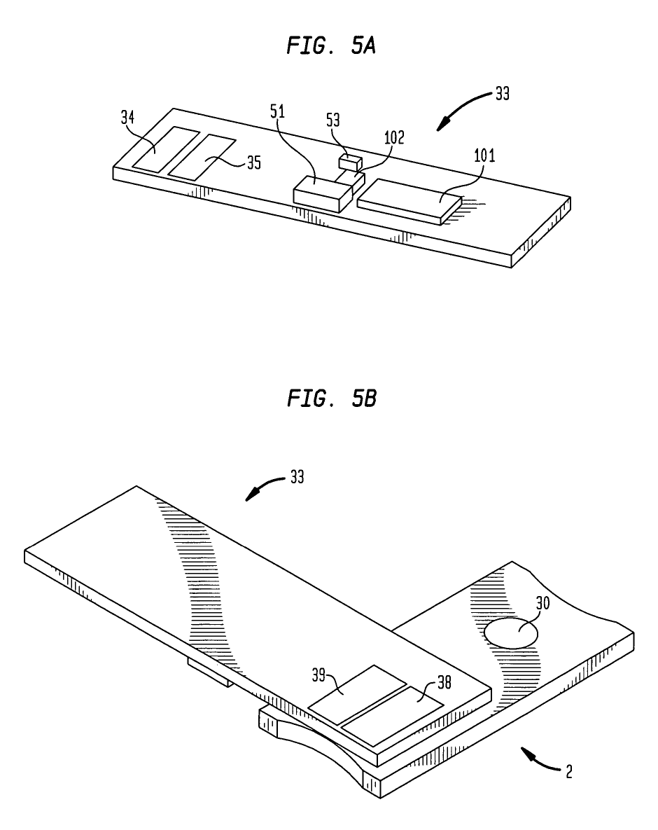

FIG. 4 is a schematic diagram of a replacement electronic circuit for the electrical contact type of printer. The processor 101 illustrated in this schematic may be a 20-pin surface mount device. The interconnect ground contact 34 and the interconnect data contact 35 are referred to in FIG. 5A and may be electronically connected to the inoperable circuit's printer interfacing contacts, the original electronic circuit data contact 32 (FIG. 7) and the original electronic circuit ground contact 31. The replacement electronic circuit printer interfacing ground contact 38 and replacement electronic circuit printer interfacing data contact 39 may be the contacts that will engage the printer's interfacing contacts. Contacts 42, 43, 44, 45, 46, and 47 may be used to initially program and test the processor. Resistor 49 may be utilized in order to keep the processor out of “test” mode and resistor 50 may be added for additional maintenance functionality. Specifically, this maintenance functionality may allow the processor to drive the data line to a logic high and monitor the line to make sure that electrically the port is acting appropriately.

Due to size constraints of the replacement electronic circuit, a battery may not be the most feasible alternative to power the processor. A capacitor 51 may be used to store enough voltage potential while the communications line is driven low due to communications taking place. In the preferred embodiment, a 22 μF capacitor 51 may provide enough current to keep the processor operational. In addition, a special reset circuit 102 may be used to ensure the stable operation of the processor. The purpose of this circuit is to allow enough time for the power rail to reach a minimum threshold and remain at or above that minimum level before allowing the processor to start operating. During insertion of the toner cartridge into the printer, the power applied to the replacement electronic circuit data contact 32 the original electronic circuit may fluctuate for a brief period of time. This reset circuit 102 may attempt to ensure that the power rail has had enough time to stabilize before starting the processor. As a result, the reset circuit 102 may hold the reset line of the processor 101 low for an additional 200-300 mS after a 2.25 VDC threshold has been reached. Delaying the processor 101 from starting until the power rail has become stabilized may ensure that the processor has enough power to run. In addition, a Shottky diode 53 may be placed in the design to prevent any reverse current from flowing from the capacitor 51 to the printer during times when the printer is driving the data line low.

FIGS. 5A and 5B illustrate another embodiment of a replacement electronic circuit 33. FIG. 5A shows a top perspective view of the replacement electronic circuit 33. The replacement electronic circuit 33 has two interconnect contacts, an interconnect ground contact 34 and an interconnect data contact 35. The original electronic circuit 2 may be connected to the replacement electronic circuit 33 by soldering the interconnect-ground contact 34 and the interconnect data contact 35 to the two printer interfacing electrical contacts, the original electronic circuit ground contact 31 and the original electronic circuit data contact 32 of the original electronic circuit 2.

FIG. 5B shows a bottom perspective view of the same embodiment of the replacement electronic circuit 33 as illustrated in FIG. 5A. From this view two printer interfacing electrical contacts, original electronic circuit ground contact 31 and the original electronic circuit data contact 32 may be shown. Once the original electronic circuit 2 is attached, the replacement electronic circuit 33 may need to communicate to the printer via the replacement printer interfacing electrical contacts, a replacement electronic circuit printer interfacing ground contact 38 and a replacement electronic circuit printer interfacing data contact 39. When this replacement electronic circuit may be mounted on the toner cartridge the two printer interfacing electrical contacts of the replacement electronic circuit may be facing away from the body of the waste bin 4 (FIG. 3). The fully assembled product, consisting of the original electronic circuit 2 mounted on the present invention, may be able to fit within the space of the original electronic circuit 2. Instead of soldering the two parts together, the interconnect ground contact 34 and the interconnect data contact 35 may be slightly raised or convex so that the original electronic circuit might be held in place by glue or another adhesive.

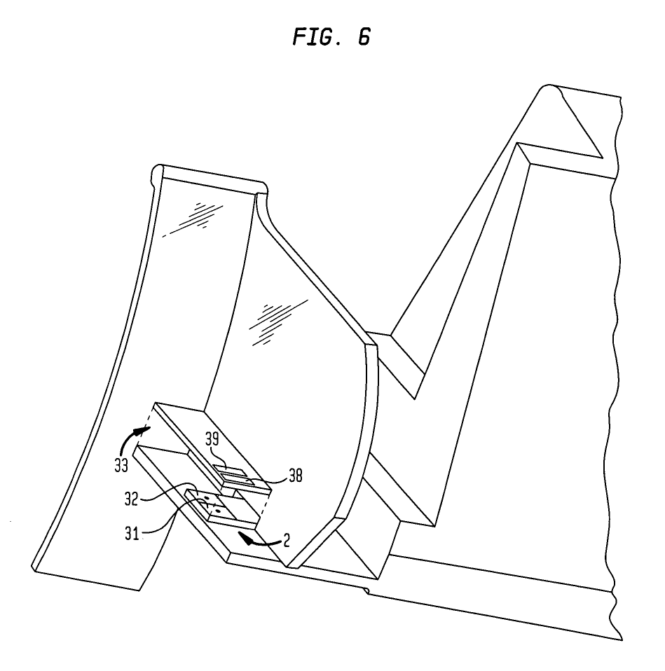

FIG. 6 shows an exploded perspective view of the replacement electronic circuit 33 as previously illustrated in FIGS. 5A and 5B. The replacement electronic circuit 33 may be installed on top of the original electronic circuit 2. In this manner the original electronic circuit 2 may not need to be removed from the replaceable consumable unit in order to install the replacement electronic circuit 33 on the replaceable consumable unit. The replacement electronic circuit 33 may then be soldered on to the original electronic circuit 2 while the original electronic circuit 2 is still attached to the replaceable consumable unit.

FIG. 7 is another illustration of a replacement electronic circuit in accordance to another embodiment of the present invention. Here the two printer interfacing electrical contacts 31 and 32 of the original electronic circuit 2 may be connected to the interconnect ground contact 34 and the interconnect data contact 35 via wires 37. An advantage of this embodiment is that it allows for the invention to be used on cartridges that may not allow much room to position the replacement electronic circuit. There may be a suitable mounting location for the replacement electronic circuit 33 away from where the original electronic circuit 2 was located, as long as connectivity to the printer contact pins can be taken into account.

This processor 101 may be initially programmed using a unique programmer. In this embodiment, the processor may need separate contacts that will allow subsequent reprogramming. This may be due to the processor requiring approximately 6.2-6.8 V DC in order to bum the appropriate memory locations. The processor may be programmed either serially via the data line of the circuit or via a parallel bus. Programming the device via the parallel bus may be accomplished more efficiently by reading and writing in bytes as opposed to bits. Conversely, the handshaking that occurs in the serial procedure will slow down the programming process. However, by having a serial process available, the design becomes more adaptable due to the fact that during the refurbishment process the microprocessor may be reprogrammed by the use of a special dongle. The processor may also be reprogrammed while still mounted on the replaceable consumable unit. This saves time and effort by not having to remove the chip, reprogram it and then reattach it.

Another major advantage of using a processor in this embodiment is that the design may be modified at a later date simply by reprogramming the device. If flexibility or adaptability may be an essential element in the design of a replacement electronic circuit, then discrete logic may not be the best alternative. By using a processor that contains intelligence, the replacement electronic circuit may also be utilized to perform additional functions that the original electronic circuit is incapable of doing. The processor 101 may be able to monitor the communication that occurs between the printer and the toner cartridge and take the appropriate action.

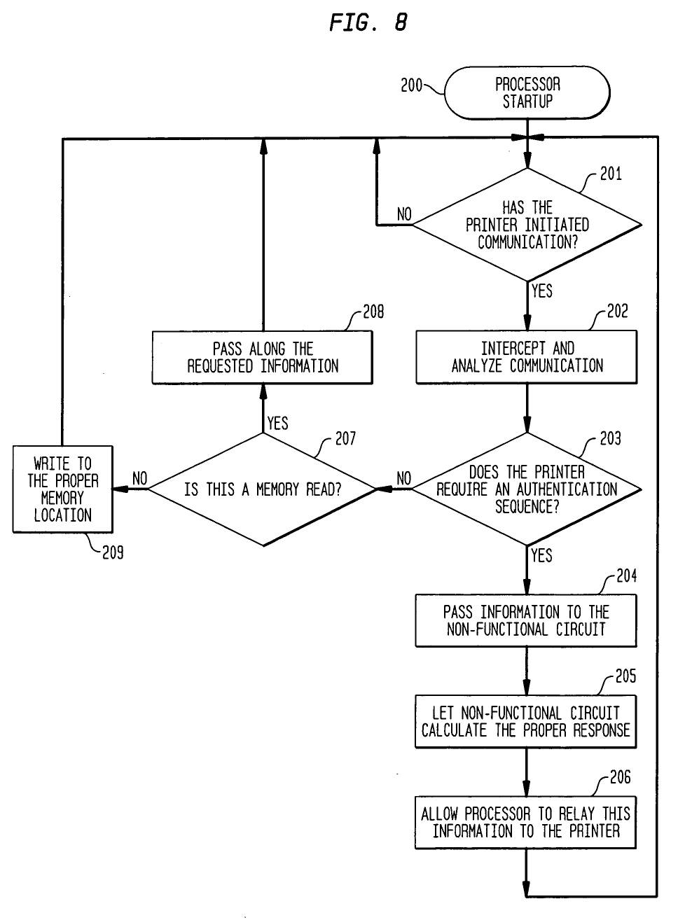

FIG. 8 is a flow chart of a method that may be performed by a replacement electronic circuit such as replacement circuit 33. Upon initial start up, the processor 101 will perform its own internal and external diagnostics in block 200. Once the printer has completed the diagnostic procedure, it may determine if the printer has initiated a communication in block 201. In this particular design architecture the circuit on the replaceable consumable device may never initiate communications with the printer. The printer may always be the master. Therefore, the processor could monitor the data line to see if the printer is trying to gain the circuit's attention. Once the printer has tried to talk to the toner cartridge, the processor 101 will intercept and analyze the communication in block 202. If the cover has been opened and shut or if the printer has gone through a power cycle the printer may initiate an authentication sequence in block 203. This may require that the proper hash may be returned to the printer before any further exchange of information will be allowed. In order to get the correct response, the information sent by the printer may need to be passed to the nonfunctional original electronic circuit 2 in block 204. The processor 101 will become the master and the nonfunctional original electronic circuit 2 may become the new slave. The nonfunctional original electronic circuit 2 may then calculate the appropriate hash value and send it to the processor in block 205. The processor 101 then could receive this information and immediately may send it back out to the printer in block 206. The processor may additionally store this value should the printer reinitiate the startup sequence again at a later time.

The printer may receive the appropriate hash and determine that it could allow information to pass down to the replaceable consumable unit. The next phase may be to read additional information stored on the device such as the current bucket level. For this to occur, the printer may start the communication as shown in block 201. This time however, no authentication sequence may be necessary because the printer has previously recognized and acknowledged the identity of the cartridge. Therefore, the function may be either a read or a write to memory locations. The processor 101 may determine if it is a read request in block 207, and if so it may access the information in block 208 and pass it along to the printer. If it is not a read request, it may be a write request, and as a result, the information may be stored by the processor in the correct memory location as shown in block 209. Once either a read or write has occurred, the processor could go back to its wait loop, waiting for the processor to once again initiate communications.

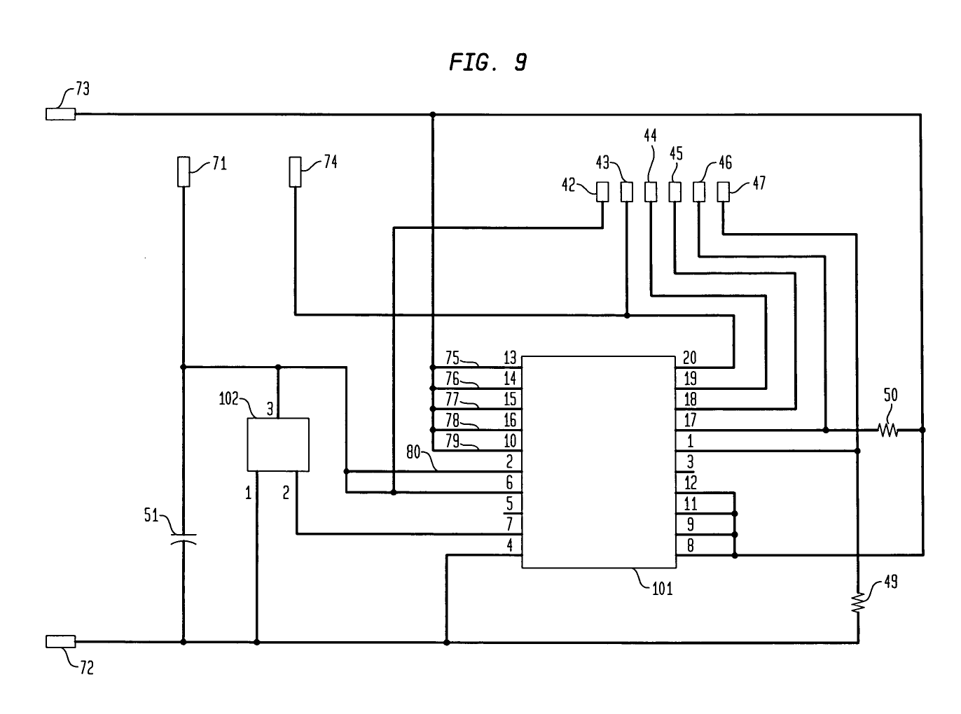

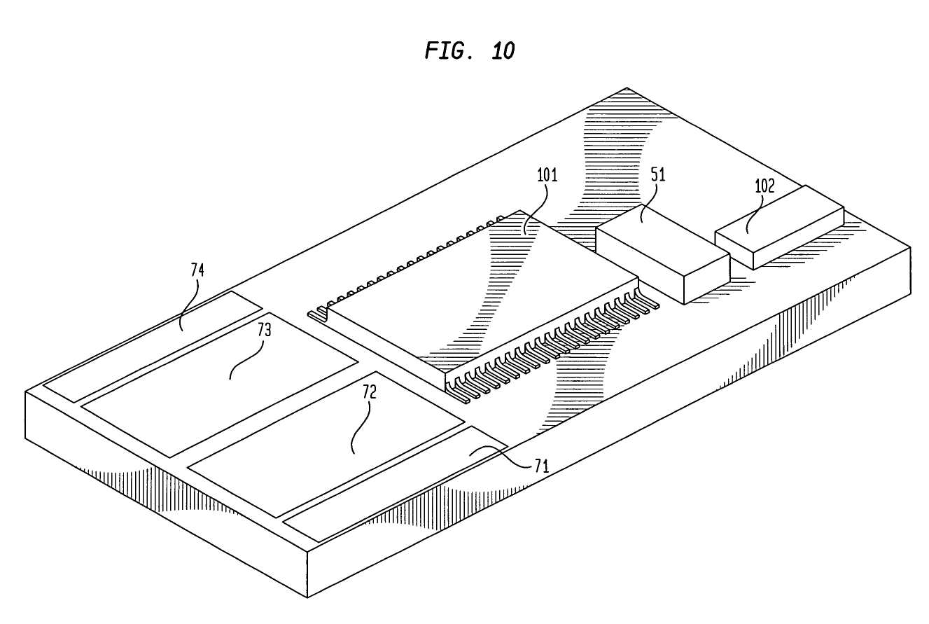

Another advantage of the embodiment is that it may incorporate the ability to be reprogrammed serially as illustrated in FIG. 9. This schematic diagram is similar to the one depicted in FIG. 4. The circuit in FIG. 9 has some major differences. Due to size constraints, the Shottky diode 53 may be eliminated and the internal diodes of the processor may be utilized instead. Second, power could be sent through several input pins of the processor 75, 76, 77, 78, and 79. This process may charge the capacitor 51 and activate the reset circuit 102 through the passive VCC pin 80. The programming voltage necessary to reprogram the part may be provided on the voltage contact 71. The new programming data may be sent down the serial programming data contact 74. The data contact of the replacement circuit 73 and the ground contact 72 are in the same orientation as the replacement electronic circuit printer interfacing ground contact 38 and replacement electronic circuit printer interfacing data contact 39 of the secondary circuit design. This new design as shown in FIG. 9, may be used as a complete replacement to the nonfunctional original electronic circuit 2. The design of this embodiment of the present invention may assume that the processor is able to return the appropriate hash value to the printer and that the use of the nonfunctional original electronic circuit 2 is unnecessary. FIG. 10 is an illustration of the physical board layout of the previously discussed embodiment illustrated in FIG. 9. During the reprogramming activity, the toner cartridge may be removed from the printer and a programming dongle could be applied to the replacement electronic circuit and the processor 101 may be reprogrammed. A casing that houses the replacement electronic circuit might be so designed to simplify the reprogramming procedure. This might be the use of a programming dongle that would fit only one way on the casing because of an indenture. The indenture may also be used to facilitate the removal of the replacement electronic circuit should it cease to function.

Printers in general have the ability to determine how much toner remains in the current replaceable consumable unit installed in the printer. One method described in U.S. Pat. No. 5,995,772, issued to Barry, et al., describes how a paddle would measure a delay as it rotated through toner contained in a toner hopper. The amount of delay experienced by the paddle is proportional to the amount of toner remaining in the cartridge. This delay is then used in a mathematical equation to determine how much toner is remaining in the toner hopper. Another way of determining toner level is a variation of the paddle. This variation would determine how long and how far the paddle is able to freely rotate from the top of its arch to the point it contacted toner within the toner hopper. Instead of a delay, as the paddle made its way through the toner, there would be a brief period of time that the drive shaft would not be moving the paddle since it is rotating freely as it falls. Another alternative means to determine how much toner remains is to measure the electrical or magnetic characteristics of the toner remaining in the hopper. The printer would measure the impedance or capacitance across the toner and then determine the appropriate amount of toner remaining accordingly.

Once a printer has determined how much toner is remaining it has to convey this information to the end user as well as keep a running log for its own purposes. One particular way a printer stores how much toner is remaining is the use of a “bucket level.” The printer stores a value associated with the amount of toner remaining in the bucket level memory location of the electronic circuit on the replaceable consumable unit. This area of memory is capable of being written to on a very limited basis. Initially, this bucket level will be “full” on a new or newly refurbished replaceable consumable unit. As toner is consumed the bucket level will be adjusted accordingly. The bucket level can only be decremented and never incremented during the operation of the replaceable consumable unit. If the bucket levels were ever to increase by a certain percentage, then the printer would detect this as an unauthorized attempt to refill the replaceable consumable unit and it will disable the particular replaceable consumable unit. Printer manufacturers have determined that most replaceable consumable units, once installed into a printer, may not be refilled during its current life cycle. Once the amount of usable toner has been determined to be “empty” by the printer, the printer will then store an “empty” bucket level value in the electronic circuit. Thereafter the printer will disable the replaceable consumable unit from operating by writing to another location in the circuit memory that is analogous to an “on/off” switch. In order for the printer to operate the location must correspond to an “on” value. Once this location has been rewritten with an “off” value the replaceable consumable unit will no longer function. The cartridge will then either be recycled or thrown away. The process of making these locations in memory unalterable is analogous to recording information on a 3½″ floppy diskette, that has a write protection tab. Once the memory protection tab has been changed, the floppy becomes write protected.

In order to better understand the additional functionality that a replacement circuit may be able to offer, it is important to understand the significant parts of the replaceable consumable unit. Some of these parts in particular may be controlled by the actions of the replacement circuit.

The operation of a typical xerographic replaceable consumable unit is described in the U.S. Pat. No. 5,012,289 issued Apr. 30, 1991 to Aldrich, et al. In this patent, the process by which toner is transferred from the toner hopper to the developer roller and then to the Organic Photo Conductor (OPC) is outlined in great detail. FIG. 11 is an illustration of a prior art toner hopper assembly of a cartridge that utilizes this type of process. This is the same toner hopper assembly shown in FIG. 1. Once the toner hopper assembly 3 is separated from the waste bin assembly 4 the individual components may be identified, cleaned, replaced or refilled.

In FIG. 11, toner may be added into the toner fill hole 17 either when the cartridge is new or being refurbished. The toner hopper cap 8 fits over this hole and is held in place by pressure. This toner hopper cap 8 may contain material such as Tyvek® that will allow air to flow in and out of the toner hopper reservoir 20. The Tyvek® may have large enough pores to allow the air to flow but may restrict any toner particles from escaping. This is essential because any pressure differential between the air inside the toner hopper reservoir 20 and the surrounding air may result in toner leakage from any number of critical places such as the hopper seal. The Tyvek® material may be affixed to the toner hopper cap with glue or pressure. Another alternative may be to use a heat seal to hold the Tyvek® in place.

The developer roller 24 sits on an axle and is rotated by a developer roller drive gear 12. At the opposite end of the axle, the developer roller contact bushing 11 engages the developer electrical contact 10, which allows for a DC potential to be applied across the developer roller 24 providing a charge necessary to negatively charge the toner. Sufficient voltage may be required to differentially bias the toner and may allow it to become electrically charged. As a result the toner may be attracted to the appropriate locations on the OPC drum (not shown), which may contain the image to be transferred to the print media. The OPC drum may be in close proximity to the developer roller 24 when the printer cartridge 1 is fully assembled. This proximity allows the toner to migrate from the developer roller to the OPC drum. Once toner has been transferred to the OPC drum, print media will be fed into the printer and the toner will become affixed to the media during the fusing process.

Behind the developer roller is an adder roller 15. The adder roller 15 is in physical contact with the developer roller 24 and is instrumental in ensuring a good supply of toner is presented to the developer roller. The adder roller 15 also has an adder roller electrical contact 16 that allows a potential supplied by the printer to pass through the adder roller 15. The adder roller 15 provides an initial negative charge to the toner supply. Additionally, the adder roller 15 is pressed against the developer roller 24 and the friction that results contributes additional negative charge to the toner passing between the developer roller 24 and the adder roller 15. The toner may be electrically charged in a two-stage process. The adder roller 15 may provide the initial charge, and the developer roller 24 may provide the subsequent charge.

In one particular prior art toner cartridge there is no primary charge roller (PCR). Instead the PCR is resident inside the printer. The main purpose of the PCR is to reapply an even electrical charge to the OPC drum so it will wipe clean any latent images left on the drum. As the OPC rotates, a laser will etch an image on the drum creating areas of less negatively charged surfaces that correspond to the lines or shapes of the image. As the OPC rotates and comes in contact with the developer roller 24, toner will be attracted to the less negatively charged areas on the surface of the OPC. Once the toner has become affixed to the OPC, paper or other media is introduced into the printing process. The area behind the printer will also be electrically charged to the toner then migrated to the media and is melted into place.

During the printing process the voltages applied by the printer to the electrical elements of the cartridge may vary. When a higher voltage may be applied to certain components, the resulting electric charge may be greater and more toner may be attracted to the components. As a result the print image may be darker. Over the lifetime of the cartridge, the voltages may have a tendency to fluctuate and in some cases increase substantially. This may be due to the printer manufacturers intent to ensure that there is enough toner for the components to make good quality prints. It also may be a way to use toner faster thus hastening the replaceable consumable unit's toner consumption and effectively shortening the life of the cartridge.

Some printers have the ability to change the voltages being applied to these electrical components. Prior art describes changing the voltages on these components in relation to analyzing the images as they are processed off the OPC drum, which is usually done as part of a calibration procedure. Instead of basing the voltage potential on the image, a new replacement circuit could base the voltage on a specific toner level condition. This may occur when the toner in the toner hopper has reached a “toner low” state and conservation of toner is important. By returning the voltages back to their original operating states or to any level that would make the printer use less toner, the print quality could remain the same while reducing background printing. This in turn may conserve the amount of toner being used and prolong the life of the toner cartridge. In the previously discussed examples, the voltage of the PCR could be maximized (highest negative voltage) at the same time the voltage of the developer roller would be minimized (least negative voltage). The appropriate values corresponding to this change could be loaded into the replacement electronic circuit once a specific toner value had been achieved. Then the next time the printer is opened or the power is cycled, this new value may be read and the changes could then be implemented. An alternative embodiment could change the voltage of the PCR to become minimized and the voltage to the developer roller to become maximized. The voltages may be changed in numerous combinations, depending on the specific printer and the desired results.

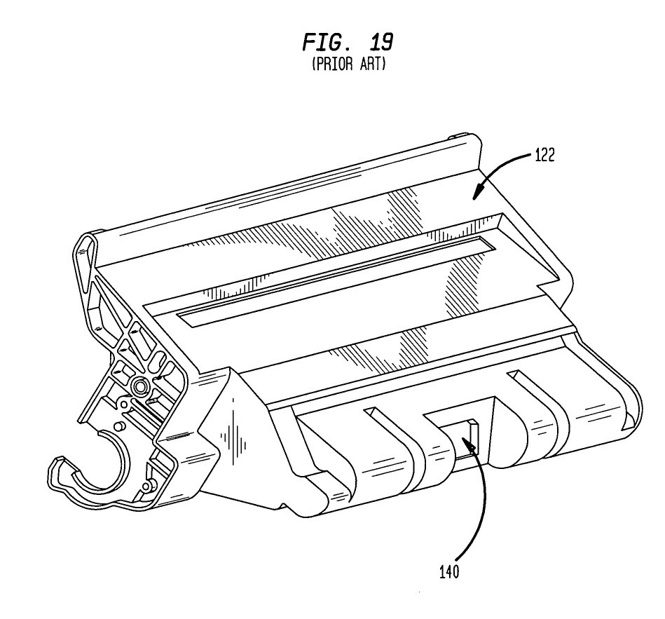

As had been discussed previously, the original electronic circuit used for a toner cartridge may employ different communication schemes. They may be either a contact or a wireless communication platform. In particular, the wireless platforms involve the printer providing power to the electronic circuit via the RF waveforms. These circuits may be housed in a plastic casing and could be mounted on the toner cartridge. In these toner cartridges, the original electronic circuits may be mounted in an area that is form fitted for the specific casings. FIG. 18 shows a prior art wireless communication toner cartridge 120. This toner cartridge is similar in structure to the contact communication toner cartridge illustrated in FIG. 1. The wireless communication toner cartridge 120 has a wireless communication toner hopper reservoir 121 and a wireless communication waste bin assembly 122. FIG. 19 shows wireless communication waste bin assembly 122 in greater detail. The original electronic circuit casing 140 for this cartridge may be shown mounted in the rear portion of the wireless communication waste bin assembly 122. The original electronic circuit may be located inside the housing. The area where the original electronic circuit casing 140 is mounted may be restricted by certain physical boundaries. As such, any improvement to the original electronic circuit casing 140 may need to be accomplished without increasing its original dimensions. Some of the embodiments of the present invention adhere to this restriction, while others take advantage of additional room that might exist on other replaceable consumable units.

An example of the prior art original electronic circuit casing 140 is further illustrated in FIG. 12. The original electronic circuit casing 140 consists of a top surface 91, a bottom surface 92 (not shown), a first end 93, a second end 94, a front side 95 and a back side 96. The height of the front side 95, back side 96, second end 94, and first end 93 may depend upon the thickness of the replacement circuitry as well as the height allowance in the mounting area of the cartridge. Since the replacement electronic circuit may be in close proximity to the printer's receiver/transmitter, the height may be a critical issue. In the preferred embodiment, the replacement electronic circuit casing will be flush with the surrounding structure of the wireless communication waste bin assembly 122.

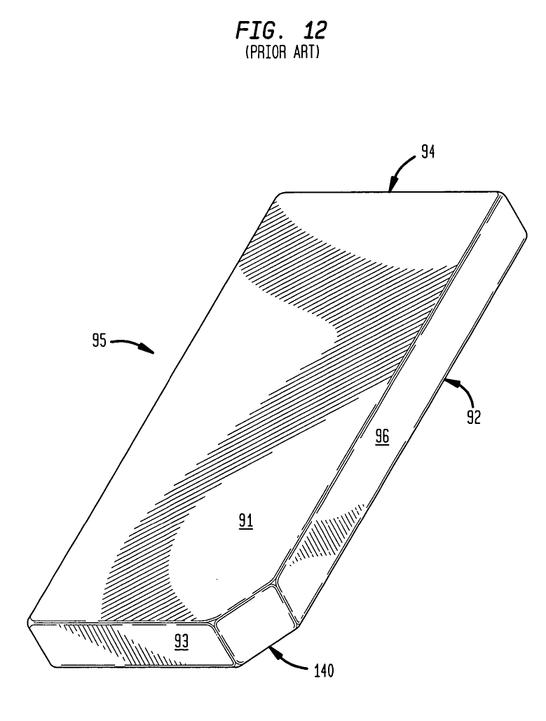

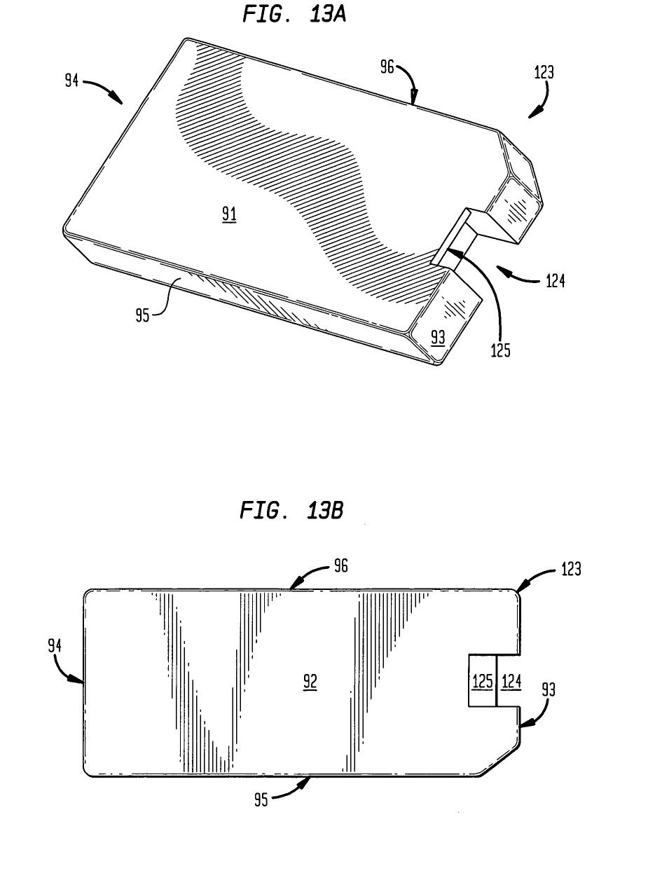

FIG. 13A shows a replacement electronic circuit casing 123 in accordance with an embodiment of the present invention. Here the replacement electronic circuit casing 123 has kept the original physical dimensions of the original electronic circuit casing 140 with the exception of an indentation 124. This indentation 124 provides a service technician a more efficient way of removing the replacement electronic circuit casing 123. This indentation 124 may provide the ability to remove the replacement electronic circuit casing 123 by simply inserting a small tool such as a miniature flathead screwdriver into the indentation 124, positioning the tool in between the replacement electronic circuit casing 123 and the body of the waste bin assembly. To further facilitate the removal process, a ledge 125 may be incorporated into the indentation 124. FIG. 13B is a bottom view of the replacement electronic circuit casing 123 clearly showing the indentation 124 as well as the ledge 125. This ledge 125, in conjunction with the indentation would provide a prying surface that would make removing the replacement electronic circuit casing 123 even easier. In the previous example of a flathead screwdriver, the head would not have to be pushed in between the replacement electronic circuit casing 123 and the body of the waste bin assembly. Instead, a curved implement can be used. The advantage of incorporating the ledge into the preferred embodiment is that more force would be applied in the opposing direction of the adhesive holding the replacement electronic circuit casing 123 in place.

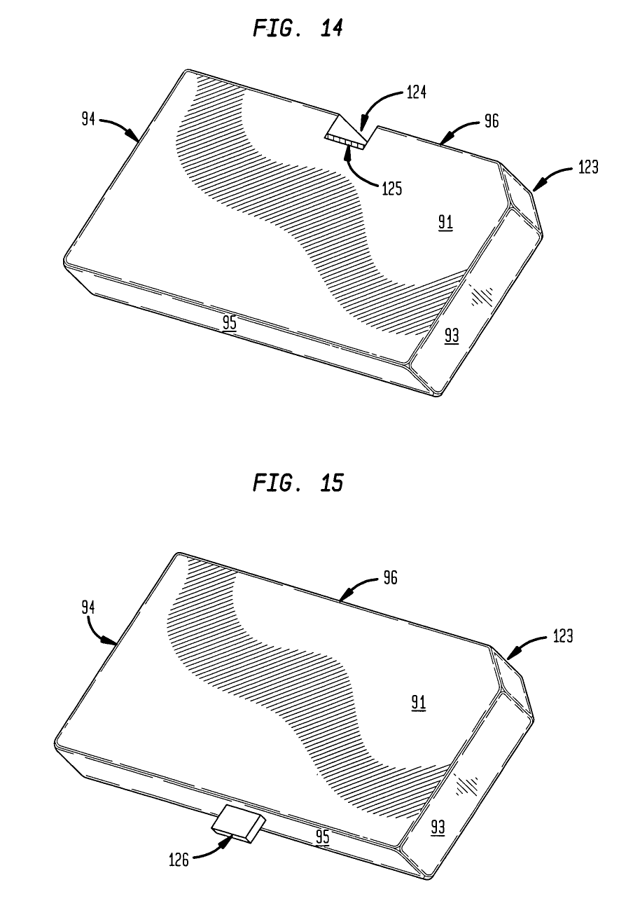

A variation to the embodiment in FIG. 13A is shown in FIG. 14. Here the replacement electronic circuit casing 123 has an indentation 124 on the back side 96 as opposed to an end of the replacement electronic circuit casing 123. A ledge 125 may also be employed in this embodiment. In both the examples illustrated in FIG. 13A and FIG. 14, the indentation 124 may be centered on the respective wall. The indentation 124 may also be off center, and possibly an uneven shape. This embodiment may also have multiple indentations to the plurality of walls to facilitate the removal by using multiple tools.

Another embodiment of the present invention is shown in FIG. 15. Here the replacement electronic circuit casing 123 may be similar to the original electronic circuit casing 140, with the exception that there may be a protrusion 126 emanating away from one of the surfaces of the replacement electronic circuit casing 123. This protrusion 126 could be designed to withstand the resultant pressure inflicted by a removal tool. The longer the protrusion 126, the less force it may take to shear the protrusion 126 from the replacement electronic circuit casing 123. The protrusion 126 could also take into account the most optimum location given the space constraints as well as the most efficient place to use a removal tool.

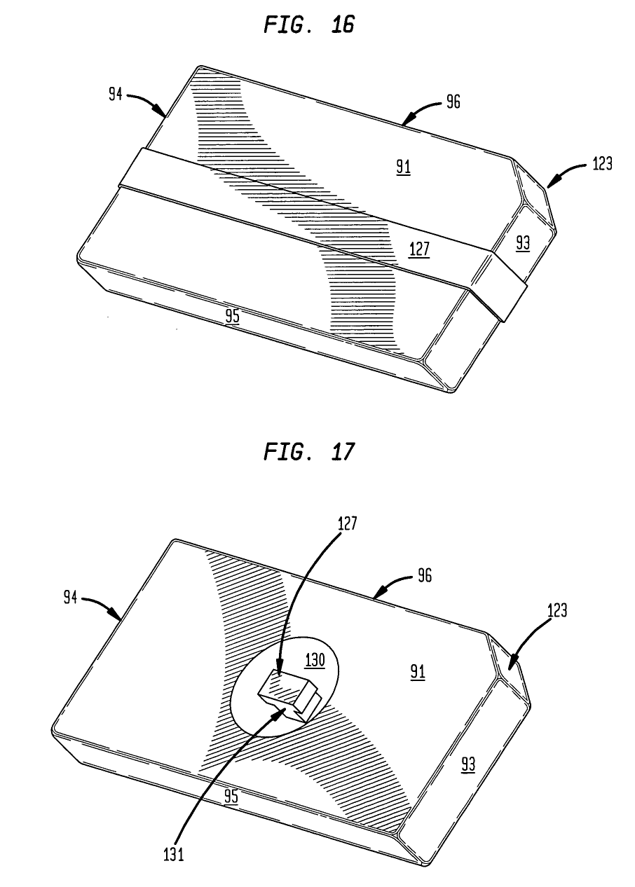

FIG. 16 shows a replacement electronic circuit casing 123 in accordance with another embodiment of the present invention. In this embodiment, the removal fixture 127 may be a string or a strap that is attached on at least one end. The removal fixture in this example could be attached to any of the walls. The most efficient way might be to attach to either the top surface 91, the first end 93 or the second end 94, but this is not a limitation of the attachment.

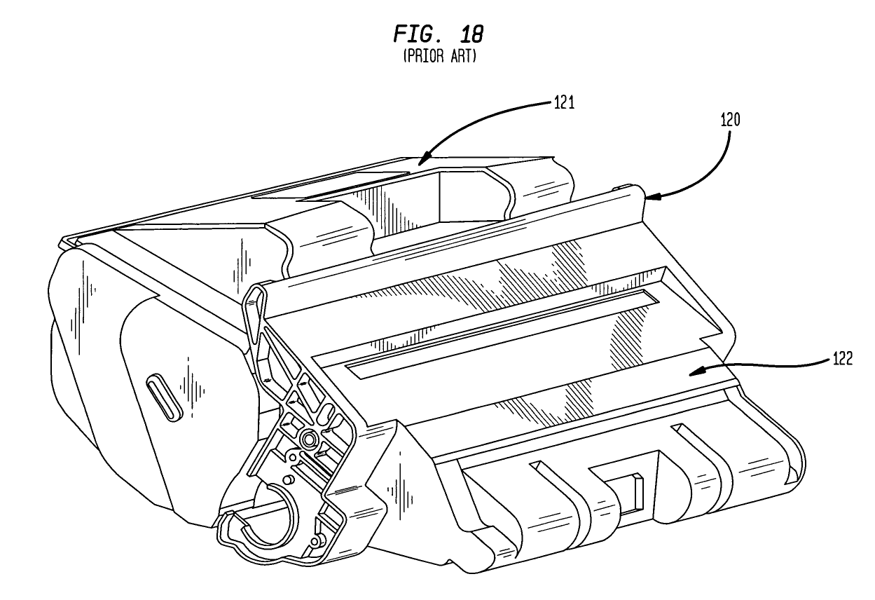

By contrast, FIG. 17 shows a replacement electronic circuit casing 123, which has a removal fixture 127 that is more complex. The replacement electronic circuit casing 123 may have a concave depression 130 in the top surface 91 of the replacement electronic circuit casing 123, with a post 131 that extends upwards. A pair of pliers could be used to grasp this post and pull the electronic circuit casing away from the wireless communication waste bin assembly 122. In this example, the top of the post 131 may be flush with the top surface 91.

In another embodiment of the present invention, the replacement electronic circuit casing may be designed to have multiple features that will facilitate removal by multiple tools. As an illustrative example, the replacement electronic circuit casing may have an indenture as well as a ledge. A tool that may fit into an indenture might be used in conjunction with another tool that may contact a ledge. These tools may be used individually, sequentially or even simultaneously with respect to each other. A replacement electronic circuit casing might have multiple indentures or multiple ledges that may be utilized by an automated process to remove the casing from the printer cartridge.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. An electronic circuit casing, comprising:
a plurality of walls forming the casing; and
at least one structure formed in at least one of the plurality of walls to facilitate removal of the casing from a surface.

2. The electronic circuit casing of claim 1, wherein the at least one structure is an indenture.

3. The electronic circuit casing of claim 2, wherein the indenture comprises a ledge adapted to receive a tool to facilitate removal of the casing.

4. The electronic circuit casing of claim 1, where the at least one structure is a protrusion adapted to receive a tool to facilitate removal of the casing.

5. The electronic circuit casing of claim 1, wherein the at least one structure is a removal fixture.

6. The electronic circuit casing of claim 5, wherein the removal fixture is a strap attached to two walls of the plurality of walls.

7. The electronic circuit casing of claim 1, wherein the surface is one of a replaceable consumable unit and a subassembly of a printer cartridge.

8. The electronic circuit casing of claim 1, wherein the electronic circuit casing is adapted to contain an electronic circuit for communicating between the replaceable consumable unit and the printer.

9. The electronic circuit casing of claim 1, wherein the at least one structure comprises a plurality of structures to facilitate removal of the casing by using a plurality of tools.

10. An electronic circuit casing comprising:
a plurality of walls, said plurality of walls comprising a top surface, a bottom surface, a first end, a second end, a front side and a back side, said top surface being connected to said bottom surface by said first end, said second end, said front side, and said back side;
at least one structure formed in at least one of the plurality of walls to facilitate removal of the casing from a surface; and
an electronic circuit used to communicate between a replaceable consumable unit and an imaging device, said circuit being encased in said casing.

11. The electronic circuit casing of claim 10, wherein the structure is an indenture.

12. The electronic circuit casing of claim 11, wherein the indenture comprises a ledge adapted to receive a tool to facilitate removal of the casing.

13. The casing of claim 11 wherein the indenture is substantially square.

14. The casing of claim 11 wherein the indenture is substantially elliptical.

15. The casing of claim 11 wherein the indenture is a substantially semi-circular.

16. The casing of claim 10 wherein the indenture is a substantially rectangular.

17. An electronic circuit casing comprising:
a plurality of walls, said plurality of walls comprising a top surface, a bottom surface, a first end, a second end, a front side and a back side, said top surface being connected to said bottom surface by said first end, said second end, said front side, and said back side;
a removal fixture connected to any of said plurality of walls; and
an electronic circuit used to communicate between a replaceable consumable unit and an imaging device, said circuit being encased in said casing.

18. The casing of claim 17 wherein the removal fixture extends above the top surface.

19. The casing of claim 17 wherein the removal fixture is embedded in the top surface.

20. The casing of claim 17 wherein the removal fixture is a strap.

21. The casing of claim 17 wherein the removal fixture is a post.

22. The casing of claim 17 wherein the removal fixture is adapted to receive a tool to facilitate removal of the casing.

23. An electronic circuit casing comprising:
a plurality of walls, said plurality of walls comprising a top surface, a bottom surface, a first end, a second end, a front side and a back side, said top surface connected to said bottom surface by said first end, said second end, said front side, and said back side;
a removal protrusion, said removal protrusion protruding from any one of the plurality of walls; and
an electronic circuit used to communicate between the replaceable consumable unit and an imaging device, said circuit encased in said casing.

24. The casing of claim 23 wherein the removal protrusion is flush with any of the plurality of walls.

25. The casing of claim 23 wherein the removal protrusion is orthogonal relative to any one of the plurality of walls.

26. The casing of claim 23 wherein the removal protrusion is adapted to receive a tool to facilitate removal of the casing.

27. A method of making an electronic casing, comprising:
forming a plurality of walls to form the casing; and
forming at least one structure in at least one of the plurality of walls to facilitate removal of the casing from a surface.

28. The method in claim 27 wherein forming the at least one structure comprises forming an indenture.

29. The method in claim 28 wherein forming the indenture comprises forming a ledge adapted to receive a tool to facilitate removal of the casing.

30. The method in claim 27 wherein forming the at least one structure comprises forming a protrusion adapted to receive a tool to facilitate removal of the casing.

31. The method in claim 27, wherein forming the at least one structure comprises forming a removal fixture.

32. The method in claim 31, wherein forming the removal fixture comprises attaching a strap to two walls of the plurality of walls.

33. The method in claim 27, wherein the surface is one of a replaceable consumable unit and a subassembly of a printer cartridge.

34. A method of refurbishing a printer cartridge, comprising:
applying a force to at least one structure formed in an electronic circuit casing, said casing being attached to said printer cartridge;
removing the electronic circuit casing from the printer cartridge by applying said force; and
replacing the removed electronic circuit casing with a new casing.

35. The method of claim 34, wherein the new casing comprises an electronic circuit adapted to communicate between the printer cartridge and a printer.

36. The method of claim 35, wherein the electronic circuit comprises electrical contacts adapted to communicate between the printer and the printer cartridge.

37. The method of claim 35, wherein the electronic circuit comprises a wireless interface adapted to communicate between the printer and the printer cartridge.

38. The method of claim 34, wherein the at least one structure is an indenture and wherein applying the force comprises applying the force to the indenture.

39. The method in claim 38, wherein the indenture comprises a ledge adapted to receive a tool to facilitate removal of the casing.

40. The method in claim 34, wherein the at least one structure is a removal fixture and wherein applying the force comprises applying the force to the removal fixture.

41. The method in claim 40, wherein the removal fixture is a strap attached to two walls of a plurality of walls formed on said electronic circuit casing and wherein applying the force comprises applying the force to the strap.

42. The method of claim 34, wherein the new casing comprises a programmable electronic circuit to avoid removal of the new casing when the printer cartridge is subsequently refurbished.
